(19) United States
(12) Patent Application Publication
(10) Pub. No.: US 2002/0151080 A1
(43) Pub. Date: Oct. 17, 2002

(54) Continuous on-line titrations by feedback based flow ratiometry

(75) Inventors: Purnendu K. Dasgupta, Lubbock, TX (US); Hideji Tanaka, Tokushima (JP)

Correspondence Address: George M. Cooper, P.O. Box 2266 Eads Station, Arlington, VA, 22202, US

(73) Assignee: TexasTech University

(21) Appl. No.: 09/780,434

(22) Filed: Feb. 12, 2001

Related U.S. Application Data
(60) Provisional application No. 60/212,671, filed on Jun. 20, 2000.

(51) Int. Cl. G01N 31/16

(52) U.S. Cl. 436/55; 436/163

(57) ABSTRACT

Continuous on-line titrations based on feedback-controlled flow and the principle of compensating errors are carried out in a titration system by maintaining a constant total flow of mixed sample and titrant. The flow of the titrant is varied in response to a controller output voltage, and accordingly, the makeup sample flow also varies but inversely to the titrant flow. A detector monitors the status of the indicator color in the mixed stream.

The controller output varies upwardly or downwardly in response to the detector output. The controller initially ramps upwardly to increase titrant flow. When the detector senses a color change, it causes the controller output to reverse and ramp downwardly. This reduces the titrant flow until another color change is detected, which again reverses the controller output. This is repeated to obtain an accurate equivalence flow rate by compensating for the lag time between the occurrence of an equivalence in the mixed stream and its detection.

This application claims the benefit of U.S. Provisional Application No. 60/212671, filed Jun. 20, 2000, the disclosure of which is hereby incorporated herein by reference.

### BACKGROUND OF THE INVENTION

The present invention relates, in general, to the field of volumetric analysis, and more particularly to flow titration utilizing feedback-based flow ramp reversal.

Titrimetry is one of the few classical analytical methods still in wide use, for the determination of both major and minor components (the latter most notably for the measurement of water by Karl Fisher titrations). Titrations are not limited to solutions.

Indeed, the origin of titrimetry has been traced back to Geoffroy in 1729; he evaluated the quality of vinegar by noting the quantity of solid K₂CO₃ that could be added before effervescence ceased.

The foundation of volumetric analysis, as it is presently known, was laid by Gay-Lussac between 1824 and 1832. Mohr is especially credited for popularizing volumetric analysis, through the 1855 publication of his classic treatise on titrimetry. Compared to competing techniques, titrimetry exhibits excellent precision, convenience and affordability, but it is generally confined to a batch operation with slow throughput and requires significant amounts of sample and titrant. As long as the titrant concentration is exactly known and volumetric ware needs no further calibration, true titrations require no calibration curve. This can be important in situations where it is difficult to prepare a pure standard solution of the analyte being titrated.

In routine analytical laboratories, automated titrators, often coupled to robotic workstations, have largely replaced manual titration. The hardware and algorithms for end point detection and the consequent feedback to control the rate of titrant addition have become increasingly sophisticated. In the research laboratory, titrators have been greatly miniaturized and automated and titrations have been demonstrated down to the femtoliter scale. The intrinsic batchwise nature of this measurement has however, remained unaltered in such efforts.

More than three decades ago, the paradigm of titrations from the volume to the flow domain was introduced. The basic arrangement involves two pumps; one pumps the sample at a constant rate while the other, a feedback based servo-controlled pump, delivers the titrant. The two streams are merged, and some desired property of the mixed stream (such as electrode potential) is measured by a suitable detector. In response to the detector output, the titrant pump changes speed and attempts to maintain the detector output at some constant level. This general system has been copied, reinvented, reconfigured, and (over)simplified numerous times since its original description, and linear titration plots have been shown to be possible.

However, manual rather than feedback based control of the titrant pump is still being advocated, with finite pauses at discrete mixing ratios so as to allow the detector output to reach the equilibrium value reflective of that mixing ratio. This generates a complete multipoint titration curve. Such seemingly retrograde movements highlight the fact that the same problem faced by batch mode autotitrators reappears in the flow domain, perhaps in a more aggravated fashion. In the batch titration mode, following incremental titrant addition, a finite mixing and detection time is necessary before a detector reading is meaningful. In flow titrations, aside from the above factors, the time for the fluid transport to the detector is additionally necessary after a flow rate change. Altogether, these contribute to the overall lag time between the equivalence composition (or some other desired set point) being first reached at the sample-titrant confluence point and this actually being registered by the detector. Mixing is a more problematic issue in flow systems because it is difficult to incorporate active mixing (magnetic stirrers etc.) without incurring additional mixing volume that increases the lag time further. Detector response time can also be factor. Optical detector response is rapid but potentiometric detection, especially with a glass electrode, can be slow. Because of the sigmoidal nature of most titration curves (near the end point the change in the detector output is most rapid), the existence of a finite lag time is particularly important. Autotitrators solve this problem by reducing titrant delivery speed in proportion to the rate of change of the detector output, even performing discrete small incremental additions near the end point for highest accuracy. There is no barrier to implementing the same methodology in the flow domain, to perform measurements with discrete changes in the flow ratio while waiting at each step for a steady state reading and with progressively smaller changes as the end point is approached. Either this approach or the concept of holding the system at the end point in a steady state under feedback control has the virtue that they are true titrations. As long as the pumps are calibrated (in much the same way that volumetric ware used in conventional titrations have implicit calibrations), no further system calibration with samples of known concentration is needed. They have, however, the considerable disadvantages of a substantial time (>5 min) and sample/titrant consumption per titration. For applications as on-line process titrators, the significant time involved can cause a real problem in streams with fast-changing compositions.

Many ingenious and innovative approaches to solving these problems have emerged. The detector output has been used as the index to perform a half-interval search in the sample:titrant ratio to attain the equivalence point with excellent precision in under 3 min per titration. With air bubbles at each end of a trial mixture to isolate it from the next mixture (monosegmented flow), the method could be used for even slow detectors without a major increase in the time spent.

In such a binary approach to attain the end point, a maximum of n compositional trials are necessary for a desired accuracy of 1 part in 2 . One approach is to use two variable speed pumps, which alternate their roles as sample/titrant pumps with the help of two 3-way valves. A titration is performed one way and then the pumps change their role to perform the titration again and an average of the two compensates for the lag time. Further, the temporal flow profile for the pumps are exponential, rather than linear, to provide better accuracy.

There are also other techniques, even though they are not true titrations in that calibration is required, such as concentration gradients in the titrant, rather than a flow gradient; such gradients can be generated by exponential mixing or by electrochemical generation of the titrant.

In more recent years, flow injection titrations have been introduced. In this approach, the width of an injected response peak at some set point, often the equivalence point, is measured and is linearly proportional to the logarithm of the injected concentration. Although gradient dilution chambers are advocated, they are not essential. While logarithmic response permits a large dynamic range, precision is limited. To get 1% accuracy, analysis time can be several min per sample and changes in sample viscosity can compromise accuracy. Instead, using the configuration of FIG. 1, the time to reach a titration end point, beginning from a zero titrant flow, as deduced from an indicator color change occurring as a result of a linear change in titrant flow rate, is linearly related to the sample concentration. This may be a more attractive approach in terms of time and precision. Further, for the purist, it is more likely to qualify as a titration. However, the problems of reducing the time for carrying out an accurate titration still remains.

### SUMMARY OF THE INVENTION

The present invention is directed to a new paradigm for continuous flow titrations by feedback-based flow ratiometry in which the lag time between sample-titrant confluence and detection of the status of the titration is made constant. The error in measuring the titration results due to a lag time, whether the lag is due to the resident time in the mixer or is due to the detector response time, is continuously compensated for by averaging rapid backward and forward titrations.

In accordance with the invention, continuous on-line titrations are based on feedback-controlled flow-ratiometry where the ratio of sample flow to titrant flow is held equal to the ratio of sample concentration to titrant concentration, and on the principle of compensating errors. System and methods operating under these principles have been thoroughly tested by applying them to acid-base neutralization titrations with indicator-based end-point detection, and will be described in terms of such tests for convenience. However, it will be understood that the invention is not limited to the titration of these particular samples or titrants. In a typical case, a total flow F_{T}, consisting of sample and titrant flows, is held constant while the titrant flow F_{B} varies linearly in response to a controller output voltage. The sample (e.g., an acidic solution to be titrated) flow F_{A} constitutes the makeup (the difference between the titrant flow F_{B} and the total flow F_{T}) and is added to the titrant at a point of confluence to provide the mixed stream F_{T} Thus when the titrant flow is varied the sample flow also varies in the reverse direction (F_{A}=F_{T}−F_{B}). The status of the mixed stream F_{T} is monitored by a detector and used either for governing the controller output or for interpreting the results of the titration. The titrant may be a standard base solution containing an indicator, in which case the detector may be an optical detector. However, it will be understood that other titrant solutions may be used to vary the properties of the mixed stream, with the detector being appropriate to the property to be detected.

Three methods of control were tested: a PID based control, a fixed flow rate control and a feedback-based flow rate control, with the last-named method being the preferred embodiment of this invention. In this latter approach, the titrant flow is initially ramped upward in accordance with a preselected flow rate pattern. At the instant a change in a selected property of the mixed stream is sensed by the detector, the actual titrant flow rate F_{H} (which is produced by the upwardly ramping flow control signal) is higher than the true equivalence flow rate F_{E} because of the lag time between the occurrence of the first property change and its detection. The sensing of the change in property is used to cause the system controller output to immediately reverse its ramp direction so that the titrant flow is ramped downwardly in accordance with the same flow rate pattern. At the instant another change in property, in the opposite direction this time, is detected, the titrant flow rate F_{L} (produced by the downwardly ramping flow rate control signal) is lower than F_{E} by exactly the same amount that F_{H} was higher than F_{E}. This is the principle of compensating errors (F_{E}=(F_{H}+F_{L})/2) which allows true titrations with excellent reproducibility and speed (0.6% rsd @3 s/titration and 0.2% rsd @10 s/titration), and reduced titrant volume consumption (as little as 12 μL/titration), and which solves an old conceptual problem in flow-based titration.

### BRIEF DESCRIPTION OF DRAWINGS

The foregoing, and additional objects, features and advantages of the present invention will become apparent to those of skill in the art from the following detailed description of preferred embodiments, taken with the accompanying drawings, in which:

FIG. 1 is a diagrammatic illustration of a number of prior titration systems;

FIG. 2 is a diagrammatic illustration of a titration system in accordance with the present invention;

FIG. 3 is a diagrammatic illustration of a system for varying the sample concentration in the system of FIG. 2;

FIG. 4 illustrates controller output vs time for the system of FIG. 3 using a PID flow rate controller;

FIG. 5. Illustrates controller output vs time for a triangular wave flow rate controller, showing detector output Dₒᵤₜ;

FIG. 6 illustrates, in graphs (a) and (b) the detector output vs controller voltage for a triangular wave flow rate controller over 10 titrations each of a sample of (a) 50 mM and (b) 100 mM of HCl

FIG. 7 illustrates, in graphical form, the voltage output vs time for a feedback-based controller in accordance with the present invention, having a triangular flow rate control voltage;

FIG. 8 is a graphical illustration of the feedback-based triangular flow rate control method of the invention utilizing a continuous change in analyte concentration, illustrating in graph (a) function generator output FGₒᵤₜ that governs the analyte concentration and controller output V_{C} vs. time, and illustrating in graph (b) the reciprocal of the controller output at equivalence (1/V_{E}), which tracks the function generator output; and

FIG. 9 is a graphical illustration of the controller output vs detector output for two different analyte concentrations in a feedback-based triangular wave control method in accordance with one embodiment of the invention.

### DETAILED DESCRIPTION OF PREFERRED EMBODIMENTS

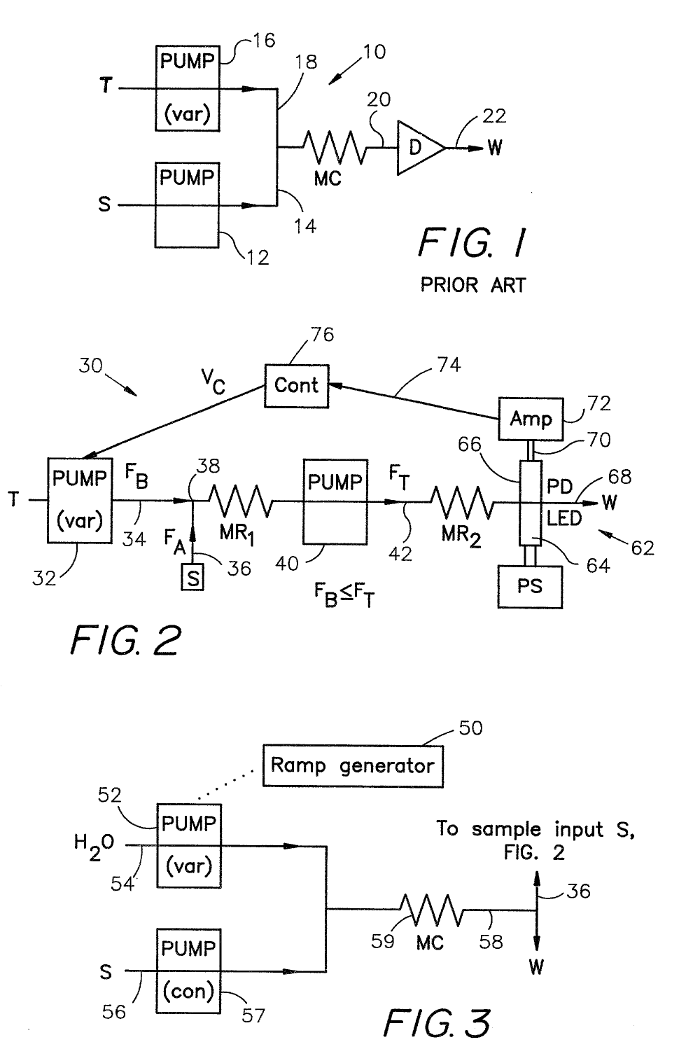

As previously described, FIG. 1 illustrates the known Blaedel-Laessig titration configuration 10, wherein a sample S is supplied by a pump 12 to a mixing coil MC through a supply line 14. The titrant T is supplied to mixing coil MC through a variable pump 16 and line 18, and a detector D measures property changes in a mixed stream in flow line 20 from the mixing coil, with the waste fluid W flowing from the detector by way of outlet line 22.

The basic flow diagram of a titration system 30 in accordance with the present invention is shown in FIG. 2, wherein a variable titrant pump 32 supplies a titrant T through an output line 34 to produce a flow F_{B} to a mixing reactor MR. A sample source S supplies a sample through line 36 to produce flow F_{A}, with the titrant flow on line 34 aspirating the sample at junction 38 and carrying it to the mixing reactor MR. In prior configurations, variations in pump flow rates resulted in variations in total flow rate and a fixed hardware arrangement produced corresponding variations in the lag time between sample titrant confluence at function 38 and subsequent detection. To overcome this variation, the configuration of FIG. 2 includes a pump 40 which keeps the total flow rate F_{T} from the reactor MR constant, and includes a flow rate controller (to be described) for titrant pump 32. The flow rate F_{B} of the pump 32 is adjusted to be equal to or just below F_{T}. The sample flow rate F_{A} represents the difference between F_{T} and the titrant flow rate F_{B}. Since the mixed stream F_{T} from pump 40 to reactor MR on line 42 varies between 100% sample and 100% titrant, it is possible in principle to titrate a sample of any concentration with a titrant of any concentration. However, to obtain good precision and accuracy, a judicious choice of titrant concentration is appropriate, based on the sample concentration.

In experiments, the sample concentration was varied as a function of time using the arrangement illustrated in FIG. 3. A ramp generator 50, such as a Tektronix FG 504 function generator, was connected to a voltage-controlled pump 52 to vary the flow of water in line 54 to dilute a constant flow of a sample stream on line 56 provided by a constant rate pump 57. The water and the sample were mixed at a mixing coil MC to provide a mixed stream on line 58. Part of this mixed stream on line 58 was aspirated through the sample aspiration line 36 shown in FIG. 2, while the rest was allowed to go to waste (W).

Variable speed pumps such as Gilson Minipuls 2 or Rainin Rabbit-Plus/Dynamax pumps, having 10 stainless steel rollers, were used for the pumping needs. The variable pumps 16, 32 and 52 may be externally voltage-controlled with a 0-5 V DC analog input. For good mixing without significant residence time, single bead string reactors MR₁ and MR₂, each incorporating, for example, a single strand chain of beads with an average bead diameter of 0.5 mm, were contained in a tube having 0.81 i.d. and 25 mm long, were used on both the inlet and outlet of the final pump 40, illustrated in FIG. 2. Residence time for mixing is less critical in the system of FIG. 3, so a mixing coil MC (600 mm×0.66 mm i.d.) indicated at 59, suffices for this purpose. Except as stated, 0.51 mm i.d. Pharmed pump tubes, or lines, were used throughout, with the total flow rate F_{T} held constant at 1.9 mL/min.

Although changes in various properties of the total flow may be measured to determine titration end points, the use of indicators in the titrant to change the color of the sample is common, and the following description of tests of the present invention will be in terms of such indicators in combination with optical detectors. It will be understood, however, that the invention is not limited to such indicators or to optical detection methods, but is equally applicable to, for example, potentiometric or conductometric detection methods. In one example of the invention, a conventional indicator was premixed in the titrant T and the optical absorption of the indicator present in the mixed stream F_{T} was measured by a simple on-tube Light Emitting Diode (LED)-photodiode (PD) based detector 62. The detector 62 used in the experiment described above consisted of a ¼-28 threaded male-male union with a center partition made for chromatography (P/N 39056, Dionex) with an LED 64 emitting at 605 nm (P/N HAA5566X, Stanley Electric, Tokyo) on one side and a silicon photodiode 66 (PD, P/N BPW 34, Siemens) on the other. transparent tubing 68 of FEP Teflon (0.8 mm i.d., 1.2 mm o.d.) carrying the mixed stream F_{T} passed between LED 64 and PD 66 in a perpendicular fashion. The PD produced an output 70 which was supplied to a current amplifier 72 (Amp, Model 427, Keithley) which typically was set at its minimum response time of 10 μs, and the resulting amplifier output voltage on line 74, which was linearly related to the optical transmittance of tubing 68 and its contents, was supplied to a controller 76.

Two different controllers were utilized in the above-described experiments. The first controller was a commercially available PID type process controller (Omega CN76160), while the second incorporated a personal computer (PC)-based system with a control algorithm written as described below. As an intermediate step in operating the latter system, a function generator (Tektronix FG 504) was used in place of the PC based system to ramp the flow produced by the titrant pump 32 up and down, in a blind fashion. The output from the amplifier 72 and from controller 76, as well as other operating parameters were acquired on a PC using a 12-bit data acquisition card (DAS-1601, Keithley/Metrabyte). In the case of the fully PC-based system, a PCMCIA card (PCM-DAS16D/12AO 12-bit A/D, D/A, Computerboards Inc., Middleboro, Mass.) housed in a Pentium II-class notebook computer (Latitude, Dell Computer Corp.) was used. Commercially available reagents of analytical reagent grade (indicator grade for indicators) were used without further purification in the task of the present invention.

Tests were carried out using the configuration of FIG. 2. In this configuration, at the equivalence point of the titration the following equation will hold:

C_{A}(F_{T}−F_{E})=C_{B}F_{E} (Eq. 1)

where C_{A} and C_{B} represent the concentration of sample and titrant respectively, and F_{T} is the invariant total flow rate of the system. The titrant flow rate F_{B} is designated F_{E} at the equivalence point. In these tests, generally the sample was an acid and the titrant was a standard base solution already containing an indicator. The value of F_{B} was linearly related to the output voltage V_{C} from the controller 76. Thus, Eq. 1 is rewritten as follows:

C_{A}(F_{T}−kV_{E})=C_{B}kV_{E} (Eq. 2)

where k is a constant of proportionality, kV_{E} is equal to F_{E}, and V_{E} is the value of V_{C} at the equivalence point. Therefore, 1/V_{E} is proportional to 1/C_{A} in the configuration shown in FIG. 2, all other terms in the following equation being constant:

(V_{E})⁻¹=(kC_{B}/F_{T})(C_{A})⁻¹+k/F_{T} (Eq. 3)

Proportional Integral Derivative (PID) controllers are widely used for control of temperature, pressure and other process parameters, and many controllers of this type are commercially available. In a test, such a controller was connected to maintain the system of FIG. 2 at such a titrant flow rate that the mixed stream F_{T} was exactly neutralized in a strong acid-strong base titration. The titrant was 100 mM NaOH containing 0.2 mM bromthymol blue (BTB); sample: 50-200 mM HCl. There was no buffer capacity at the equivalence point except for that provided by the indicator, and a very slight deviation caused an indicator color change. The detector output at 74 was measured with the mixed stream distinctly acidic, where the indicator was completely yellow, and distinctly basic where the indicator was completely blue, and the controller was set to maintain the detector output at the midpoint of these acidic and basic values. Under these conditions, if steady state control can be achieved, V_{C} will directly reflect analyte concentration since F_{B} is linearly related to V_{C}.

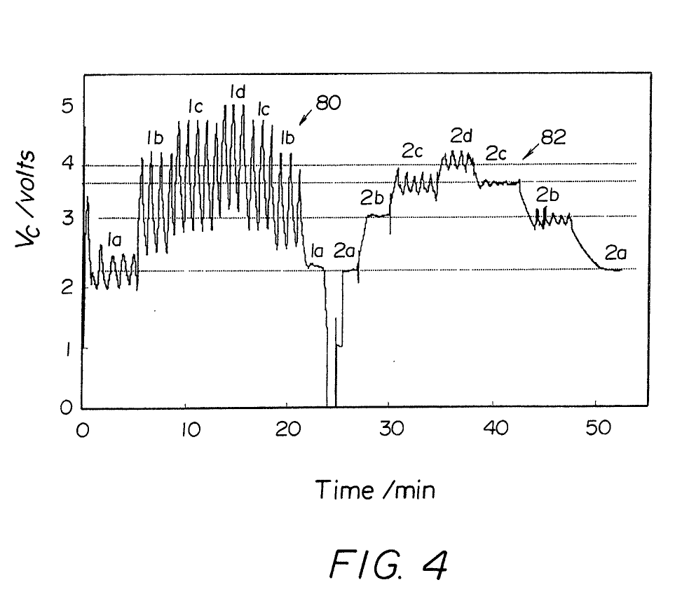

Self-tuning abilities are provided in most modern microprocessor based PID controllers to find optimum values of P (gain), I (bias) and D (time constant) to maintain good control. For the present system, where the detector output is practically bistable with a sharp transition between two states (indicator blue and indicator yellow), self-tuning was ineffective to maintain control. The controller output oscillated between its highest and lowest permitted values. Manual settings of the PID values led to better results; the control voltages for two runs is shown in FIG. 4 at graphs 80 and 82. In graph 80, the PID values were set at P=25, I=0.1 and D=off, and the controller output was obtained as the HCI concentration in the sample was varied from 50 mM to 200 mM and back to 5 mM in seven steps, illustrated at points 1a to 1d. In the test, step 1a=50 mM, step 1b=100 mM, step 1c=150 mM, and step 1d=200 mM. In graph 82, the same steps in sample concentration were used, at 2a-2d, with the PID values set at P=100, I=0.1 and D=0.01.

It was found that some degree of control was possible with high P and low D values. With an increase of P value, oscillation became less significant, but it took a longer time for the system to stabilize at the set point. No significant improvements were observed by using greater time constants for the detector to reduce detector noise, or by reducing lag time by placing the detector on the aspiration side of the final pump 40 (FIG. 2). It was also found that the degree of oscillation for the same sample concentration can be unpredictable, as illustrated by graphs 80 and 82. More importantly, if the midpoint of each oscillation is V_{E}, the relative standard deviations would be significant. Accordingly, PID control is not particularly well suited for maintaining a system at the equivalence point where the rate of change is very steep near the set point.

The foregoing difficulty can be overcome, in accordance with the preferred form of the present invention, by scanning the titrant flow in the vicinity of the equivalence point, without attempting to keep the mixed effluent at equivalence. If the titrant flow is being ramped upwards linearly, for example, at the instant a change in the color is sensed by the detector, the titrant flow rate F_{H} is higher than the true equivalence flow rate F_{E} because of the lag between the time equivalence is reached in the mixing reactor MR and the time the mixed liquid reaches the detector, for during that time lag, the titrant flow continues to increase. Calibration of an entire system can include implicitly taking into account this lag time. F_{E} can also be expressed as:

F_{E}=kV_{E}=F_{H}−rt_{lag} (Eq. 4)

Where r is the ramp rate (dF_{B}/dt) and t_{lag}, the lag time, is a combination of the physical transit time from the confluence point and the detector response time. There may be nothing wrong with calibrating the system with standards for subsequent assays except that it ceases to be a true titration; calibrations beyond flow rates are required. This may be a nontrivial issue; if a system is calibrated for use with one set point, it may have to be calibrated again for use with another set point, since for example, the precise response times of a glass electrode varies depending on the pH regime.

If, however, the titrant flow F_{B} is then decreased from its high value at the same ramp rate r, and the instant of a change in color, in the opposite direction this time, is again sensed, the measured titrant flow rate F_{L} will be lower than F_{E}, in a mirror image fashion of the previous situation:

F_{E}=kV_{E}=F_{L}+rt_{lag} (Eq. 5)

F_{E} may then be calculated from Eqs. 4 and 5 without the use of system calibrations and without knowing the specific values of r and t_{lag}, thus permitting true titrations:

F_{E}=(F_{H}+F_{L})/2 (Eq.6)

We refer to this herein as the principle of compensating errors.

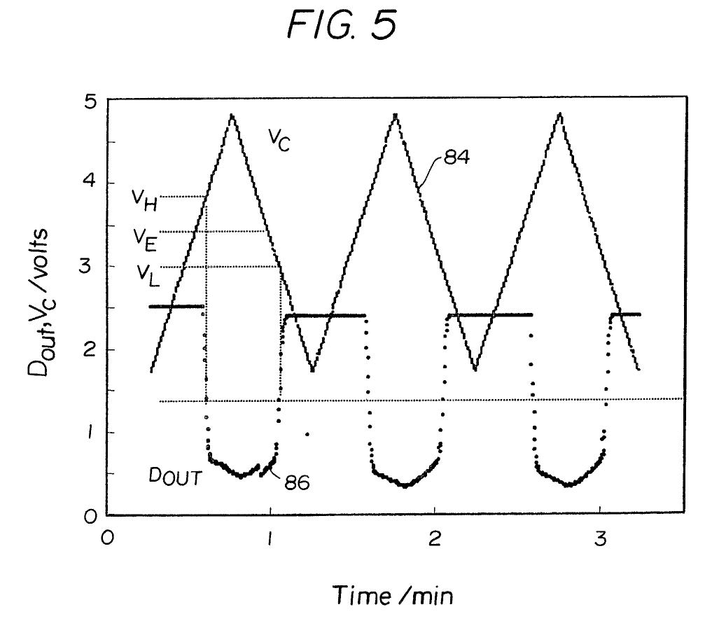

This concept was tested using a controller 76 that is simply a generator producing a triangular wave V_{C}, where the triangular wave is used to control F_{B}, as illustrated at curve 84 in FIG. 5. Actual data output, utilizing the sample titrant described above, with a 100 mM HCl, at a ramp rate of 100 mV/s is shown in FIG. 5. In response to the triangular wave V_{C} controlling the titrant flow, the detector output Dₒᵤₜ on line 74, illustrated at 86 in FIG. 5, basically executes a rectangular wave pattern. The yellow form of the indicator had practically no absorption at the monitoring wavelength. Thus at the high end, Dₒᵤₜ is flat. On the other hand, even after the indicator turns blue, further increase of F_{B} brings still more indicator in the system, since the indicator is incorporated in the titrant, and at the low end, Dₒᵤₜ executes a shallow V, with the bottom of the V being approximately temporally coincident with the apex of V_{C}, the difference being the lag time, t_{lag}.

The effect of the ramp rate r was examined at constant scan limits (1.0 to 4.5 V, 20%-90% of maximum pump rate) using the same NaOH—HCl system as in the previous paragraph. Pump flow rates were calibrated so that the correct value of F_{E} (or V_{E}) would be known a priori. At low to moderate values of r (0.0302, 0.0607 and 0.1203 V/s), V_{E} values obtained were in excellent agreement with the expected true value and exhibited good precision, with a relative standard deviation (RSD ) of less than 1%). However, at high scan rates (0.24 V/s), the experimental V_{E} values were inaccurate. Under these conditions, and with the t_{lag} in the system used for these tests, V_{C} reached its limits before a transition in Dₒᵤₜ was detected.

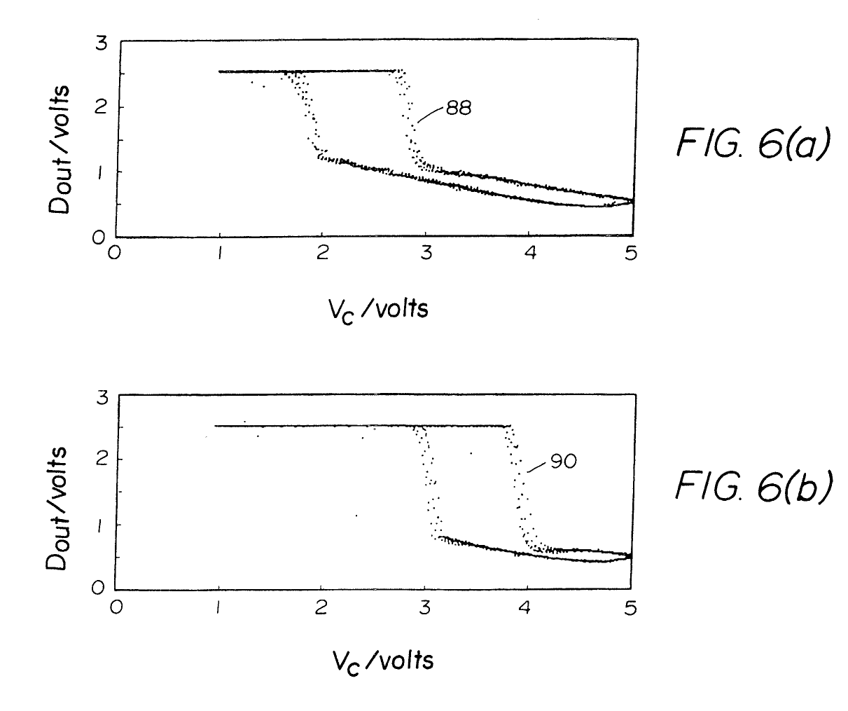

Since the number of titrations that can be conducted per unit time increases with increasing the ramp rate, or scan rate, r, further experiments were conducted with r=0.100 V/s. HCl solutions (50,75,125,150 and 200 mM) as the sample were measured with fixed scan limits of 1.0 to 5.0 V. Plotting the resulting data (1/V_{E} vs. 1/CHCl) exhibited good linearity (linear r² 0.9976). A plot of Dₒᵤₜ as a function of V_{C} is shown in FIG. 6 for 10 titrations each of (a) 50 mM (graph 88) and (b) 100 mM HCl (graph 90). V_{E} essentially represents the abscissa value corresponding to the center of mass of the parallelogram of each graph. Compared to extant literature methods, this approach is quite competitive (80 s/cycle, <1% precision), but FIG. 6 also shows very clearly that the scheme results in large amounts of time being spent in a useless manner. For example, in graph 88, the system unnecessarily scans in the VC₃ to 5 V range and similarly it spends unnecessary time in the titration of graph 90 in the VC, to 3 V range.

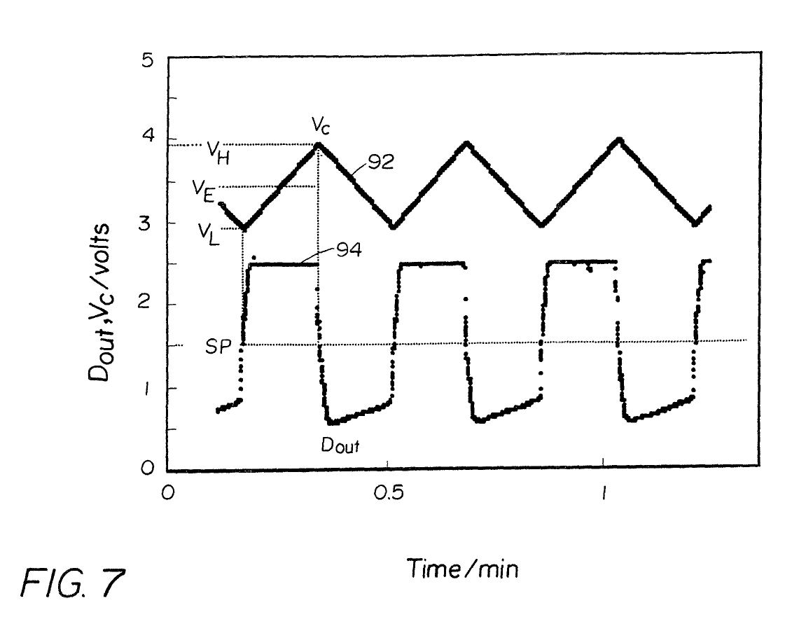

A more efficient method than the one described above, and the preferred embodiment of the invention, involves reversing the direction of the titrant pump as soon as the equivalence point is crossed. This is accomplished by sensing the detector output and changing the direction of the control voltage V_{C} as soon as some preset threshold in Dₒᵤₜ is crossed. Other standard endpoint functions based on the first or second derivatives of Dₒᵤₜ can also be implemented, if desired. Both the principle and the results are illustrated in FIG. 7, where graph 92 is the controller 76 output V_{C} and graph 94 is the detector voltage Dₒᵤₜ to the controller 76, by using the same titrant and sample as in FIG. 5. In contrast to the previous method, controller scan limits are not fixed but are, in effect, V_{H} and V_{L} and thus vary with the concentration of the analyte. As soon as Dₒᵤₜ indicates an alkaline mixture, where V_{H} has been reached, the controller output V_{C} is ramped downward. When Dₒᵤₜ indicates an acidic mixture, where V_{L} has been reached, controller output V_{C} is immediately ramped upward. The resulting V_{C} waveform 92 has a constant frequency of (4t_{lag})⁻¹ and displays an amplitude of 2rt_{lag}. Note that these properties of the V_{C} waveform are independent of the analyte concentration.

The frequency and amplitude properties of the controller output waveform suggest the possibilities of diagnosing and/or compensating for flow inconstancies, whereas the DC component of the controller output V_{C} is related to the analyte concentration. This DC bias moves up or down as the concentration of the analyte increases or decreases. The detector setpoint (Dₒᵤₜ, high) at which V_{C} begins a downward ramp does not have to be the same as the detector setpoint (Dₒᵤₜ, low) at which the ramp goes back up. This is of practical importance since all real signals contain some noise. When these points are set identically, false triggering, such as premature ramp reversal in either direction, can and will occur. To avoid such problems, Dₒᵤₜ high, should differ from Dₒᵤₜ, low, by at least 2 times the detector noise. Because the transition is very steep, it makes no real difference in the ultimate results in V_{E}.

For a discrete sample, at least one V_{H} and one V_{L} value are necessary to compute V_{E}. However, when the system is being applied continuously to a flowing stream, V_{E} values will be computed by averaging the most recent V_{H} or V_{L} value with the immediately preceding V_{L} or V_{H} value. Since the period of the V_{C} waveform is directly dependent on the lag time of the system, t_{lag}, it is essential to reduce it to improve throughput, but t_{lag} cannot be reduced indefinitely without affecting the completeness of mixing and thus increasing detector noise and decreasing system reliability. These interrelated issues are of critical importance.

The effects of positioning the detector 62 upstream or downstream of the final pump 40 and of the type and the size of the reactors MR₁ and MR₂ (for example, knotted tubing, single bead string reactor, or a porous frit-tee) at various scan rates and sample (HCl) concentrations were examined, and a representative set of results is presented in Table I.

TABLE I
Effect of detector position and reactor type

| Detector Position | D^{a} | D | D | D | D | U^{b} | U |
|---|---|---|---|---|---|---|---|
| Reactor | none | KT^{c} | KT | KT | two SBSR^{d} | SBSR | SBSR |
| Reactor length, cm | NA^{e} | 15.0 | 30.0 | 60.0 | 2 × 2.5 | 2.5 | 10.0 |
| Titration time, s | 10.4 | 12.6 | 15.5 | 20.1 | 10.2 | 3.2 | 4.6 |
| % RSD of V_{E}, (n = 20) | 0.32 | 0.46 | 0.40 | 0.35 | 0.22 | 0.56 | 0.76 |

^{a}Downstream of final pump.
^{b}Upstream of final pump.
^{c}Knotted tubing, 0.81 mm i.d..
^{d}Single bead string reactor.
^{e}Not Applicable.
Titrant: 100 mM NaOH containing mM BTB, sample 100 mM HCl, r = 0.100V/s

It was possible to reduce titration time to as little as 3.2 s with a small penalty to the precision in V_{E} (RSD 0.56%) by locating the detector upstream of pump 40 (FIG. 3). This loss of precision (although acceptable for many purposes) was attributable to increased detector noise since the active mixing provided by the pump tubing was no longer available. To improve pump induced mixing, a combination of high pump rotation rates and small bore pump tubing, rather than large bore tubing and lower rotation rates, was chosen for the desired flow rate regime. A porous frit (pore size 90-130 μm)-tee proved to be incompatible with peristaltic pumps because of its substantial resistance to flow.

The effect of changing the ramp rate r for controller 76 was examined over the 0.010-0.200 V/s range with the same titrant-sample combination as used in Table I. Table II provides a summary of the results.

TABLE II
Effect of Scan Rate

| | | | | | | | % | Titration |
|---|---|---|---|---|---|---|---|---|
| Scan rate, V/s | V_{H} | SD_{VH}^{a} | V_{L} | SD_{VL}^{a} | V_{E} | SD_{VE}^{a} | RSD_{VE} | Time, s |
| 0.01 | 3.49 | 0.01 | 3.35 | 0.02 | 3.42 | 0.01 | 0.40 | 14.3 |
| 0.025 | 3.52 | 0.02 | 3.24 | 0.02 | 3.38 | 0.01 | 0.43 | 11.6 |
| 0.05 | 3.68 | 0.02 | 3.14 | 0.01 | 3.41 | 0.01 | 0.35 | 10.8 |
| 0.075 | 3.80 | 0.01 | 3.03 | 0.01 | 3.41 | 0.01 | 0.26 | 10.35 |
| 0.1 | 3.94 | 0.01 | 2.92 | 0.01 | 3.43 | 0.01 | 0.23 | 10.2 |
| 0.15 | 4.16 | 0.03 | 2.70 | 0.02 | 3.43 | 0.02 | 0.48 | 9.8 |
| 0.2 | 4.39 | 0.02 | 2.48 | 0.03 | 3.44 | 0.02 | 0.44 | 9.6 |

^{a}Standard deviations of preceding parameters. Wherever applicable, the units are volts.

In principle, the scan rate (or ramp rate) r should not have a direct influence on the titration time. This was at least approximately true; a 20-fold increase in r resulted in only a 33% decrease of the titration time. The limited effect of r on the titration time that was observed is a practical consequence of a finite mixing and detection volume. The V_{E} values were virtually constant irrespective of the scan rate and the observed range at different scan rates was within 0.7% of the mean, and this range included the independently determined true value. V_{H} and V_{L} increasingly diverge from V_{E} as r increases, in accordance with equations. 4 and 5. A plot of V_{H} vs. r should thus have V_{E} as the intercept and a slope equal to t_{lag}. The data in Table II yields a value of V_{E}=3.430 V, a lag time t_{lag}=4.87 s, and a linear r² value of 0.9979. Similarly, a plot of V_{L} vs. r exhibits a linear r² value of 0.9979, an extrapolated V_{E} of 3.366 V, and yields t_{lag}=4.47 s. This range of V_{E} is almost the same as the range of V_{E} values observed by numerical averaging of successive V_{H} and V_{L} values at individual scan rates, lending additional credibility to the theoretical basis of the present invention.

Although the scan rate was not a major factor in determining the titration time for constant or very slowly changing sample concentrations, a higher scan rate will reach V_{H} or V_{L} values more rapidly when the sample concentration changes quickly. However, a very fast scan may result in V_{C} reaching the scan limits before a transition in Dₒᵤₜ is detected (as was noted above for a function generator controlled operation of the system without feedback, for r>0.24 V/s.) In addition, a slower scan may improve the accuracy and precision in determining V_{E}. In looking at the % RSD values for V_{E}, the RSD values increase at r>0.100 V/s and also increase at r<0.05 V/s. It was concluded that the 0.05-0.100 V/s, which corresponds to 1%-2%/s of the maximum possible pumping rate, is the best range in which to operate.

Although the herein-described experiments utilize a linear scan rate r produced by a triangular wave output from controller 76, it will be understood that not only can this scan rate be changed, it can also be varied during the scan to produce control voltages having different waveforms, with different increasing and decreasing slopes. Thus, the invention is not limited to a particular controller output pattern, or wave shape.

For virtually any process application, the sample consumption rate is not particularly important, whereas minimizing the titrant consumption is highly desirable since this decreases the replacement frequency of a reagent that must be carefully made. The utility of more concentrated NaOH solutions as titrant, in conjunction with smaller diameter (0.25 and 0.44 mm) pump tubes in addition to the original 0.51 mm diameter tube used in all the above experiments was, therefore, examined. Typical results are presented in Table III.

TABLE III
Effect of Titrant (NaOH) Concentrate^{a}

| Tubing | | | | | | | | | |
|---|---|---|---|---|---|---|---|---|---|
| i.d., | Nominal | | | | | | | % | Titration |
| mm | C_{B},M | V_{H} | SD_{VH}^{b} | V_{L} | SD_{VL} | V_{E} | SD_{VE} | RSD_{VE} | Time, s |
| 0.25 | 0.5 | 4.65 | 0.0148 | 3.62 | 0.0170 | 4.14 | 0.0112 | 0.27 | 10.35 |
| 0.25 | 1.0 | 2.76 | 0.0115 | 1.70 | 0.0116 | 2.23 | 0.0081 | 0.36 | 10.55 |
| 0.25 | 2.5 | 1.43 | 0.0187 | 0.37 | 0.0134 | 0.90 | 0.0115 | 1.28 | 10.60 |
| 0.44 | 0.5 | 2.02 | 0.0095 | 0.96 | 0.0084 | 1.49 | 0.0063 | 0.42 | 10.50 |
| 0.44 | 1.0 | 1.31 | 0.0071 | 0.27 | 0.0091 | 0.79 | 0.0057 | 0.72 | 10.40 |
| 0.51 | 0.1 | 3.81 | 0.0084 | 2.80 | 0.0132 | 3.30 | 0.0078 | 0.24 | 10.10 |
| 0.51 | 0.5 | 1.57 | 0.0130 | 0.58 | 0.0112 | 1.07 | 0.0085 | 0.79 | 9.90 |
| 0.51 | 1.0 | 1.01 | 0.0055 | 0.05 | 0.0098 | 0.56 | 0.0056 | 1.01 | 10.15 |

^{a}0.1 M HCl is sample, r = 0.100 V/s
^{b}Standard deviations of preceding parameters. Wherever applicable, the units are Volts.

A combination of low C_{B} and narrow tubing is insufficient to titrate the sample and was not tested. Likewise, a combination of high C_{B} and wider bore tubes is impractical. In general, the absolute standard deviations decreased with an increase in NaOH concentration. However, not surprisingly, the relative standard deviation increased with increasing C_{B} because V_{E} decreased more significantly compared to the standard deviation (SDV_{E}) in V_{E}. Nevertheless, the use of a small diameter (0.25 mm i.d.) tube allowed the relative standard deviation of V_{E} (RSDV_{E}) for titrations using 500 and 1000 mM NaOH to be kept well below 0.5%. Similar results, not shown, were obtained for a scan rate of 0.050 V/s. By using 1000 mM NaOH instead of 100 mM NaOH, the titrant consumption could be reduced to 18% of the original value.

Note that in the configuration of FIG. 2, the average volumetric consumption of the titrant (which is assumed to be linearly related to F_{E}) is linearly related to 1/(1+C_{B}/C_{A}). (See Equation 1). While large gains are made initially in F_{B} consumption with increasing C_{B}, there are diminishing returns on an absolute scale at higher and higher titrant concentrations. Nevertheless, it is remarkable that with a titrant concentration 25 times that of the sample, it is still possible to perform titrations with a precision only slightly over 1%, at only ˜10 s/titration and consuming 11.7 μL/titration. The precision at very high titrant/sample concentration ratios may be improved by using even smaller diameter pump tubes.

To monitor compositional changes in a stream accurately using this technique, it must be possible to carry out each forward and backward titration at a much faster rate than the rate at which the stream is changing composition.

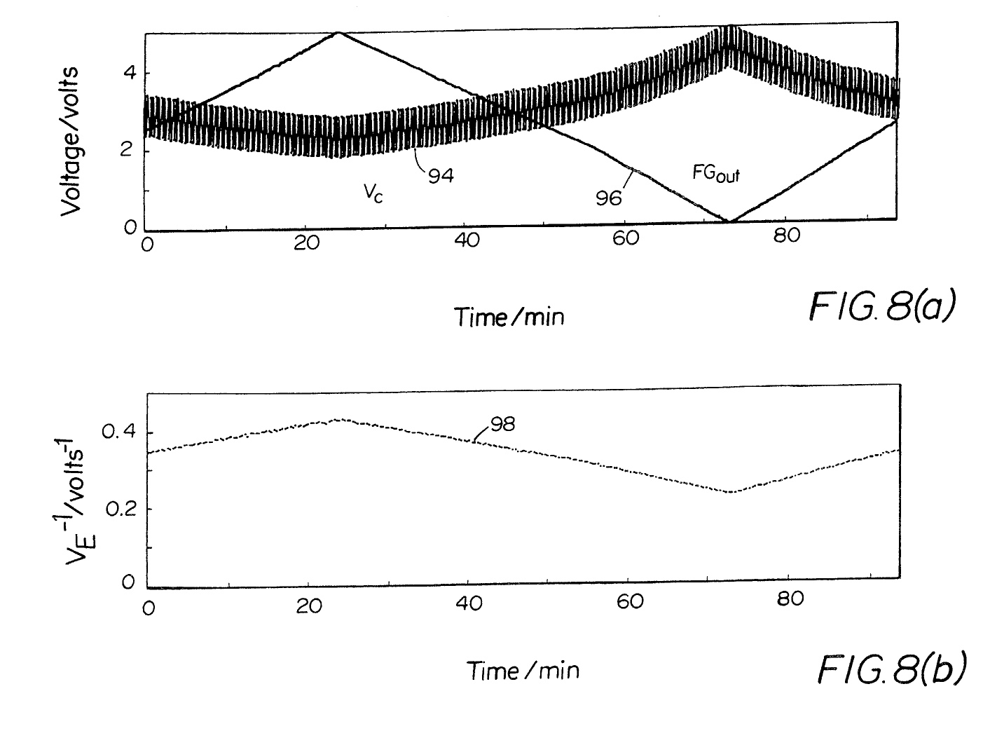

A process stream in which the reciprocal of analyte (HCl) concentration changed linearly with time was created by the system depicted in FIG. 3. The dilution flow to a constant flow stream of an acidic analyte was increased linearly with time by a slow triangular wave output (FGₒᵤₜ) of function generator 50. With a FGₒᵤₜ cycle time of 93.67 min, the minimum and maximum analyte concentrations were 50 and 180 mM. Since the entire range is spanned within one half cycle, this means the analyte concentration varied by almost a factor of four in a period of ˜45 min. This degree of change more than adequately represents the maximum change that occurs for a critical and major component in a real process stream. Six hundred and eight titrations were made within one cycle of the function generator 50, resulting in an average titration time requirement of <9.2 s per measurement. Graph (a) of FIG. 8 shows V_{C} (curve 94) and FGₒᵤₜ as a function of time. The reciprocal of V_{E} is shown similarly as a function of time in graph (b) of FIG. 8 at curve 98, and this linearly tracks FGₒᵤₜ as would be expected from theory.

The system of the present invention was applied to a number of acid-base neutralization titrations in addition to HCl—NaOH: for example CH₃COOH—NaOH, H₃PO₄—NaOH and NH₃(aq)-HCl. Indicators were selected that not only have a pK_{In} (indicator dissociation constant) value in the desired range but also that are blue in one form (basic) so that the 605 nm LED detector 62 could be used without any further modification. For H₃PO₄, titrations both at the first and second equivalence points were carried out using a separate indicator for each. The results are summarized in Table IV.

TABLE IV
Results for Different Acid-Base Neutralization Reactions

| | | | | | Number of | |
|---|---|---|---|---|---|---|
| | | | | | Individual | |
| | | | Scan Rate | Measurement | Concerns | Linear |
| Sample | Titrant^{a} | Indicator | V/s | range, mM | Examined | r2 |
| HCl | NaOH | BTB^{b} | 0.05 | 50-200 | 6 | 0.9989 |
| HCl | NaOH | BTB | 0.1 | 50-200 | 6 | 0.9991 |
| CH₃COOH | NaOH | TB^{c} | 0.05 | 25-200 | 7 | 0.9994 |
| CH₃COOH | NaOH | TB | 0.1 | 25-200 | 7 | 0.9994 |
| H₃PO₄ | NaOH | BCG^{d} | 0.05 | 12.5-200 | 9 | 1.0000 |
| H₃PO₄ | NaOH | BCG | 0.1 | 12.5-200 | 9 | 0.9996 |
| H₃PO₄ | NaOH | TP^{e} | 0.05 | 12.5-125 | 9 | 1.0000 |
| H₃PO₄ | NaOH | TP | 0.1 | 12.5-100 | 9 | 1.0000 |
| NH₃(aq) | HCl | BCG | 0.05 | 25-200 | 7 | 0.9999 |
| | HCl | BCG | 0.1 | 25-200 | 7 | 0.9999 |

^{a}100 mM contg. 200 uM indicator.
^{b}Bromothymol Blue.
^{c}Thymol Blue.
^{d}Bromocresol Green.
^{e}Thymolphthalein

The linearity refers to a Plot Of 1/V_{E} vs. the reciprocal of the analyte concentration.

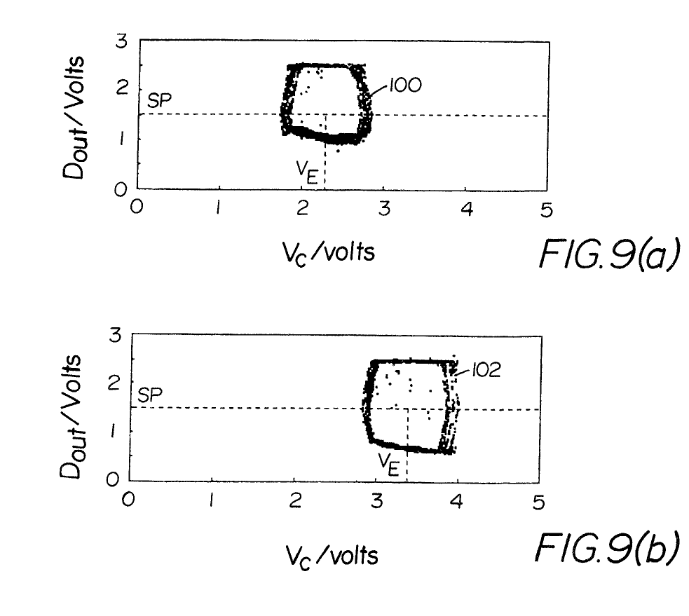

Illustrative V_{C} vs. Dₒᵤₜ plots 100 and 102 for two different HCl concentrations are shown in FIG. 9, with the data set for each plot representing a total of 20 titrations. A comparison with FIG. 6 clearly indicates the substantial superiority of the feedback-based approach. Note that these titrations were conducted with identical upward and downward ramp reversal set points. Considering that these plots are very data dense (each plot contains ˜8500 actual plotted points and the data file size for each plot exceeds 1 MB), the number of errant points are remarkably few.

The error compensated feedback based flow ratiometric titration method described here displays good precision coupled to unprecedented speed. It will be ideally coupled to continuously flowing streams, whether for measurement or control, in a variety of situations. It will permit the use of universal indicators and multiple wavelength detection for determining multiple analytes per titration for indicator based detection, and is applicable to other detection methods, such as detectors using pH electrodes. A pH electrode responds more slowly, increasing t_{lag}, but on an absolute scale, the measurement rate is still quite fast, requiring <15 s per titration.

Although the present invention has been described in terms of preferred embodiments, various modifications and variations will be apparent to those of skill in the art. Accordingly, the true scope and spirit of the invention is limited only by the following claims.

What is claimed is:

1. A titration method, comprising:
supplying a sample to a confluence point in a titration system;
supplying a titrant through a variable pump to the confluence point to mix with said sample to produce a mixed stream;
controlling the rate of flow of said titrant by varying said pump to increase or decrease the rate of flow of said titrant;
detecting a change in said mixed stream; and
changing the rate of flow of said titrant from increasing to decreasing, or from decreasing to increasing, upon said detection of a change in said mixed stream.

2. The titration method of claim 1, wherein controlling includes supplying a control voltage having a selected waveform to said pump, said waveform having an increasing slope which increases the rate of flow of said titrant and having a decreasing slope which decreases the rate of flow of said titrant.

3. The titration method of claim 2, wherein changing the rate of flow of said titrant includes supplying either said waveform increasing slope or said waveform decreasing slope to said pump in response to said detecting changes in a property of said mixed stream.

4. The titration method of claim 3, further including detecting a change in said mixed stream during at least one increasing slope and during at least one decreasing slope of said control voltage to thereby compensate for lag time in said system; and
determining titration equivalence flow from measured flow rates at said changes in said mixed stream.

5. A feedback controlled titration method, comprising:
monitoring a property of the total flow of mixed titrant and sample flows;
varying the titrant flow in a first direction;
detecting a change in the monitored property; and
varying the titrant flow in a second direction.

6. The method of claim 5, wherein varying the titrant flow includes controlling the rate of flow in said first and second directions in accordance with a predetermined waveform.

7. The method of claim 5, wherein varying the titrant flow in a first direction includes controlling the rate of flow in said first direction in accordance with a first waveform.

8. The method of claim 7, wherein varying the titrant flow in a second direction includes controlling the rate of flow in said second direction in accordance with a second wave form.

9. The method of claim 7, wherein varying the titrant flow in a second direction includes controlling the rate of flow in a second waveform which is the reverse of the first waveform.

10. The method of claim 5, further including repetitively detecting changes in the monitored property and upon each detected change reversing the direction of variation of said titrant flow to obtain an equivalence flow rate.

11. A feedback controlled titration method comprising:
controlling the flow rate of a titrant in a mixed titrant and sample flow in accordance with a first pattern;
monitoring the mixed titrant and sample flow to detect a change in a property of the mixed flow and to produce a corresponding detector output signal; and
changing the controlled titrant flow rate pattern in response to the detected change.

12. The method of claim 11, wherein changing the controlled titrant flow rate pattern includes reversing said first pattern.

13. The method of claim 11, wherein controlling the flow rate of a titrant includes varying the flow rate pattern.

14. The method of claim 13, wherein controlling the flow rate of a titrant includes increasing the flow rate in accordance with a preselected waveform.

15. The method of claim 14, wherein changing the controlled titration flow rate pattern includes decreasing the flow rate in accordance with said waveform.
